(19) United States
(12) Patent Application Publication
(10) Pub. No.: US 2018/0217806 A1
(43) Pub. Date: Aug. 2, 2018

(54) METHOD OF PROVIDING VIRTUAL REALITY USING OMNIDIRECTIONAL CAMERAS AND MICROPHONES, SOUND SIGNAL PROCESSING APPARATUS, AND IMAGE SIGNAL PROCESSING APPARATUS FOR PERFORMING METHOD THEREOF

(71) Applicant: Electronics and Telecommunications Research Institute, Daejeon (KR)

(72) Inventor: Dae Young JANG, Daejeon (KR)

(73) Assignee: Electronics and Telecommunications Research Institute, Daejeon (KR)

(21) Appl. No.: 15/662,349

(22) Filed: Jul. 28, 2017

(30) Foreign Application Priority Data
Feb. 2, 2017 (KR) 10-2017-0014898

(51) Int. Cl. G06F 3/16; G06T 7/73

(52) U.S. Cl. CPC G06F 3/165; G06T 7/74

(57) ABSTRACT

Provided is a method of providing a virtual reality using omnidirectional cameras and microphones, a sound signal processing apparatus and an image signal processing apparatus for performing method thereof. The method may include obtaining sound signals of a plurality of sound sources from a plurality of sound signal obtaining apparatuses present at different recording positions in a recording space, determining a direction of each of the sound sources relative to positions of the sound signal obtaining apparatuses based on the sound signals, matching the sound signals by each identical sound source, determining coordinates of the sound sources in the recording space based on the matched sound signals, and generating the sound signals corresponding to virtual positions of the sound signal obtaining apparatuses in the recording space based on the determined coordinates of the sound sources in the recording space and the matched sound signals.

### CROSS-REFERENCE TO RELATED APPLICATION(S)

This application claims the priority benefit of Korean Patent Application No. 10-2017-0014898 filed on Feb. 2, 2017, in the Korean Intellectual Property Office, the disclosure of which is incorporated herein by reference for all purposes.

### BACKGROUND

### 1. Field

One or more example embodiments relate to a method and apparatus for providing a virtual reality using a plurality of omnidirectional cameras and microphones, and more particularly, to a method and apparatus for providing a virtual reality by generating an omnidirectional image and sound corresponding to a position other than a photographing position and a recording position.

### 2. Description of Related Art

Recently, a virtual reality providing technology has been actively industrialized and popularized due to the development of information communication technology and changes in content production environments. The virtual reality providing technology may provide “an artificial environment that is similar to reality” by stimulating human senses.

In particular, interest in a virtual reality using a 360-degree image and sound is increasing due to a spread of head mounted display (HMD) products and small 360 virtual reality (VR) cameras. A virtual reality using a 360-degree image and sound may be classified as a three degrees of freedom (3DoF) virtual reality in which a user's head at a fixed position may rotate about three perpendicular axes, or a six degrees of freedom (6DoF) virtual reality in which a user may move freely forward, backward, up, down, left and right.

A 6DoF virtual reality is provided in content, for example, games using computer graphics. However, virtual reality content using real images and sounds may provide a 3DoF virtual reality in which movement is not free because the images and sounds are captured and recorded at fixed positions.

Thus, to increase a degree of freedom of a virtual reality using real images and sounds, a method of providing a virtual reality using real images and sounds in which a user is movable may be needed.

### SUMMARY

An aspect provides a method of providing a virtual reality in which a user is movable by using sound signals and coordinates of sound sources obtained from sound signal obtaining apparatuses present at different recording positions.

Another aspect also provides a method of providing a virtual reality in which a user is movable by using omnidirectional images and coordinates of image objects obtained from omnidirectional cameras present at different positions.

Still another aspect also provides a method of providing a virtual reality in which a user is movable by using omnidirectional sound signals and coordinates of sound sources obtained from sound signal obtaining apparatuses present at different recording positions.

Further aspect also provides a method of providing a virtual reality in which a user is movable by using coordinates of image objects and image signals obtained from image signal obtaining apparatuses present at different recording positions.

According to an aspect, there is provided a method of providing a virtual reality performed by a processor of a sound signal processing apparatus including obtaining sound signals of a plurality of sound sources from a plurality of sound signal obtaining apparatuses present at different recording positions in a recording space, determining a direction of each of the sound sources relative to positions of the sound signal obtaining apparatuses based on the sound signals, matching the sound signals by each identical sound source, determining coordinates of the sound sources in the recording space based on the matched sound signals, and generating the sound signals corresponding to virtual positions of the sound signal obtaining apparatuses in the recording space based on the determined coordinates of the sound sources in the recording space and the matched sound signals.

The determining of the direction of each of the sound sources may include determining the direction of each of the sound sources based on at least one of a time difference or a level difference between the sound signals of the sound sources from the sound signal obtaining apparatuses present at the different recording positions.

The determining of the direction of each of the sound sources may include determining the direction of each of the sound sources for each of a plurality of partial frequency bands divided from an entire frequency band of the sound signals.

The matching of the sound signals by each identical sound source may include matching the sound signals by each identical sound source based on a correlation between the sound signals.

The determining of the coordinates of the sound sources in the recording space may include determining vertical distances between the sound signal obtaining apparatuses and the sound sources and horizontal distances between the sound signal obtaining apparatuses and the sound sources based on angles between the sound signal obtaining apparatuses and the sound sources and distances between the sound signal obtaining apparatuses, and determining the coordinates of the sound sources based on the vertical distances and the horizontal distances.

The virtual positions of the sound signal obtaining apparatuses may be on a line connecting two sound signal obtaining apparatuses corresponding to the recording positions.

According to another aspect, there is provided a method of providing a virtual reality performed by a processor of an image signal processing apparatus including obtaining image signals of a plurality of image objects from a plurality of image signal obtaining apparatuses present at different recording positions in a recording space, matching the image signals by each identical image object, determining coordinates of the image objects in the recording space based on the matched image signals, and generating the image signals corresponding to virtual positions of the image signal obtaining apparatuses in the recording space based on the determined coordinates of the image objects in the recording space and the matched image signals.

The matching of the image signals by each identical image object may include matching the image signals by each identical image object based on an image matching method, and normalizing and refining the image signals.

The determining of the coordinates of the image objects in the recording space may include determining vertical distances between the image signal obtaining apparatuses and the image objects and horizontal distances between the image signal obtaining apparatuses and the image objects based on angles between the image signal obtaining apparatuses and the image objects and distances between the image signal obtaining apparatuses, and determining the coordinates of the image objects based on the vertical distances and the horizontal distances.

The generating of the image signals corresponding to the virtual positions of the image signal obtaining apparatuses may include at least one of extracting an object image, generating an intermediate viewpoint image, stitching partial background images, and replacing an image occluded by other image signal obtaining apparatuses.

The virtual positions of the image signal obtaining apparatuses may be on a line connecting two image signal obtaining apparatuses corresponding to the recording positions.

According to still another aspect, there is provided a sound signal processing apparatus for performing a method of providing a virtual reality including a processor configured to obtain sound signals of a plurality of sound sources from a plurality of sound signal obtaining apparatuses present at different recording positions in a recording space, match the sound signals by each identical sound source, determine coordinates of the sound sources in the recording space based on the matched sound signals, and generate the sound signals corresponding to virtual positions of the sound signal obtaining apparatuses in the recording space based on the determined coordinates of the sound sources in the recording space and the matched sound signals.

According to further aspect, there is provided an image signal processing apparatus for performing a method of providing a virtual reality including a processor configured to obtain image signals of a plurality of image objects from a plurality of image signal obtaining apparatuses present at different recording positions in a recording space, match the image signals by each identical image object, determine coordinates of the image objects in the recording space based on the matched image signals, and generate the image signals corresponding to virtual positions of the image signal obtaining apparatuses in the recording space based on the determined coordinates of the sound sources in the recording space and the matched sound signals.

Additional aspects of example embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 is a flowchart illustrating a method of providing a virtual reality using a sound signal obtaining apparatus according to an example embodiment;

FIG. 2 is a diagram illustrating a process of obtaining sound signals from sound sources in a recording space using two sound signal obtaining apparatuses according to an example embodiment;

FIG. 3 is a diagram illustrating an example in which two sound signal obtaining apparatuses obtain sound signals based on arrangements of sound sources according to an example embodiment;

FIG. 4 is a diagram illustrating an example of determining a position of a sound source positioned between two sound signal obtaining apparatuses in a recording space according to an example embodiment;

FIG. 5 is a diagram illustrating an example of determining a position of a sound source not positioned between two sound signal obtaining apparatuses in a recording space according to an example embodiment;

FIG. 6 is a diagram illustrating an example of generating a sound signal corresponding to a virtual position of a sound signal obtaining apparatus in a recording space according to an example embodiment;

FIG. 7 is a flowchart illustrating a method of providing a virtual reality using image signal obtaining apparatuses according to an example embodiment;

FIG. 8 is a diagram illustrating a process of obtaining image signals of backgrounds and image objects in a recording space using two image signal obtaining apparatuses according to an example embodiment;

FIG. 9 is a diagram illustrating an example in which two image signal obtaining apparatuses obtain image signals based on arrangements of image objects and backgrounds according to an example embodiment;

FIG. 10 is a diagram illustrating an example of determining a position of an image object positioned between two image signal obtaining apparatuses in a recording space according to an example embodiment;

FIG. 11 is a diagram illustrating an example of determining a position of an image object not positioned between two image signal obtaining apparatuses in a recording space according to an example embodiment; and

FIG. 12 is a diagram illustrating an example of generating an image signal corresponding to a virtual position of an image signal obtaining apparatus in a recording space according to an example embodiment.

### DETAILED DESCRIPTION

Hereinafter, some example embodiments will be described in detail with reference to the accompanying drawings. Regarding the reference numerals assigned to the elements in the drawings, it should be noted that the same elements will be designated by the same reference numerals, wherever possible, even though they are shown in different drawings. Also, in the description of embodiments, detailed description of well-known related structures or functions will be omitted when it is deemed that such description will cause ambiguous interpretation of the present disclosure.

The terminology used herein is for the purpose of describing particular embodiments only and is not intended to be limiting. As used herein, the singular forms “a,” “an,” and “the,” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Terms such as first, second, A, B, (a), (b), and the like may be used herein to describe components. Each of these terminologies is not used to define an essence, order or sequence of a corresponding component but used merely to distinguish the corresponding component from other component(s). For example, a first component may be referred to a second component, and similarly the second component may also be referred to as the first component.

It will be understood that when an element is referred to as being “connected” or “coupled” to another element, it may be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion.

Unless otherwise defined, all terms, including technical and scientific terms, used herein have the same meaning as commonly understood by one of ordinary skill in the art to which this disclosure pertains. Terms, such as those defined in commonly used dictionaries, are to be interpreted as having a meaning that is consistent with their meaning in the context of the relevant art, and are not to be interpreted in an idealized or overly formal sense unless expressly so defined herein.

Hereinafter, examples are described in detail with reference to the accompanying drawings. Like reference numerals in the drawings denote like elements, and a known function or configuration will be omitted herein.

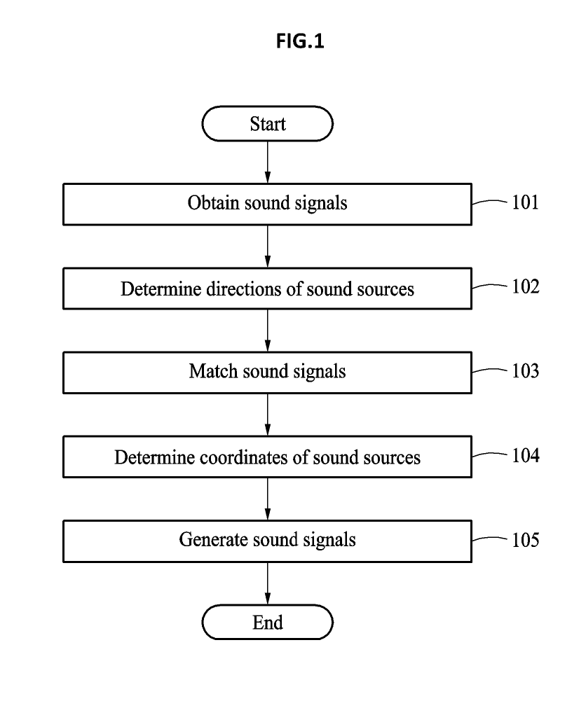

FIG. 1 is a flowchart illustrating a method of providing a virtual reality using a sound signal obtaining apparatus according to an example embodiment.

Referring to FIG. 1, a processor of a sound signal processing apparatus may perform the method of providing the virtual reality.

In an example, a plurality of sound signal obtaining apparatuses may obtain sound signals in a recording space in which a plurality of sound sources are present. Here, the recording space includes all spaces in which sound signals are obtainable. The recording space is not limited to a predetermined place or an indoor space. The plurality of sound signal obtaining apparatuses may be present at different recording positions in the recording space. The sound signal processing apparatus obtains sound signals from the sound signal obtaining apparatuses. Subsequently, the sound signal processing apparatus performs the method of providing virtual reality using the obtained sound signals.

In operation 101, the sound signal processing apparatus obtains the sound signals from the sound signal obtaining apparatuses in the recording space. A plurality of sound signal obtaining apparatuses may be provided, and the sound signal obtaining apparatuses may be present at different positions. Also, the sound signal obtaining apparatuses may be combined with other apparatuses, or included in other apparatuses. The sound signals obtained by the sound signal obtaining apparatuses include an omnidirectional sound signal including a 360-degree sound signal.

In operation 102, the sound signal processing apparatus determines directions of the sound sources relative to the sound signal obtaining apparatuses using the obtained sound signals. In an example, the sound signal processing apparatus may determine the directions of sound sources relative to the sound signal obtaining apparatuses based on a time difference between the sound signals. In another example, the sound signal processing apparatus may determine the directions of sound sources relative to the sound signal obtaining apparatuses based on a level difference between the sound sources. In still another example, the sound signal processing apparatus may determine the directions of sound sources relative to the sound signal obtaining apparatuses based on the time difference and the level difference between the sound signals. However, this is only an example. Any type of methods of determining directions of sound sources is in the present disclosure. A direction of each of the sound sources may indicate a direction relative to the sound signal obtaining apparatuses, and the directions of the sound sources may be indicated based on angles formed by the sound sources and the sound signal obtaining apparatuses.

In operation 103, the sound signal processing apparatus matches the sound signals by each identical sound source by comparing the sound signals. Here, the sound signal processing apparatus may use features of the sound signals coming from the sound sources. In an example, the sound signal processing apparatus may match sound signals having relatively high correlations to sound signals with respect to an identical sound source based on a correlation between the obtained sound signals.

In operation 104, the sound signal processing apparatus determines coordinates of the sound sources in the recording space using the matched sound signals. In an example, the coordinates of sound sources in the recording space may be determined based on the directions of sound sources relative to the sound signal obtaining apparatuses and distances between the sound signal obtaining apparatuses. Thus, the sound signal processing apparatus may determine relative positions of the sound sources relative to a predetermined position in the recording space based on the determined coordinates of the sound sources in the recording space.

In operation 105, the sound signal processing apparatus generates sound signals corresponding to the predetermined position in the recording space based on the coordinates of the sound sources in the recording space and the matched sound signals. In an example, the sound signal processing apparatus may determine the relative positions of sound sources relative to virtual positions of the sound signal obtaining apparatuses. The sound signal processing apparatus may generate new sound signals corresponding to the determined relative positions by controlling the sound signals based on the relative positions. The sound signals generated by the sound signal processing apparatus include an omnidirectional sound signal including a sound signal in a 360-degree direction.

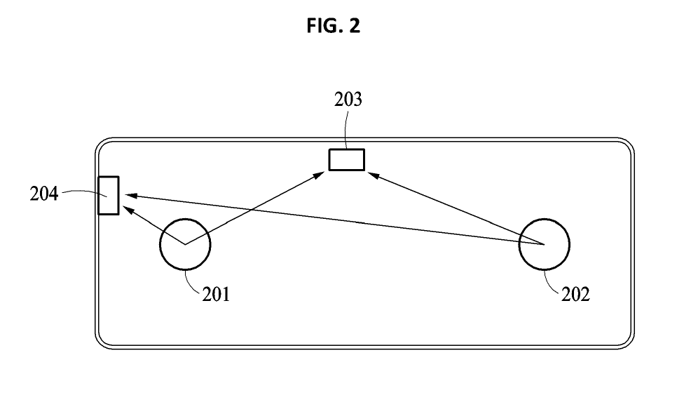

FIG. 2 is a diagram illustrating a process of obtaining sound signals from sound sources in a recording space using two sound signal obtaining apparatuses according to an example embodiment.

FIG. 2 illustrates a first sound signal obtaining apparatus 201, a second sound signal obtaining apparatus 202, a first sound source 203, and a second sound source 204 in a recording space.

In an example, a plurality of the sound signal obtaining apparatuses 201 and 202 for obtaining sound signals are disposed in the recording space. Although FIG. 2 illustrates two sound signal obtaining apparatuses 201 and 202 and two sound sources 203 and 204, the present disclosure is not limited thereto. In an example, the sound signal obtaining apparatuses 201 and 202 may include a microphone for omnidirectionally obtaining sound signals by rotating 360 degrees.

In another example, the sound signal obtaining apparatuses 201 and 202 may include a plurality of microphones for separately obtaining 360-degree sound signals. However, this is only an example. Any type of apparatuses for obtaining sound signals at 360 degrees may be in the present disclosure. In another example, a number of sound sources, for example, the sound sources 203 and 204, present in the recording space may correspond to a predetermined number. The sound signals obtained by the sound signal obtaining apparatuses 201 and 202 may include an omnidirectional sound signal.

The sound signal obtaining apparatuses 201 and 202 may obtain the sound signals of the sound sources 203 and 204 present in the recording space. The sound signal processing apparatus may estimate positions of the sound sources 203 and 204 in the recording space using the sound signals obtained by the sound signal obtaining apparatuses 201 and 202. The positions of the sound signal obtaining apparatuses 201 and 202 may be differently set. Because distances and directions of the predetermined sound sources 203 and 204 and sound signal obtaining apparatuses 201 and 202 are different, the sound signal obtaining apparatuses 201 and 202 disposed in the recording space may obtain different results of sound signals even though the sound signals are obtained from the identical sound sources 203 and 204.

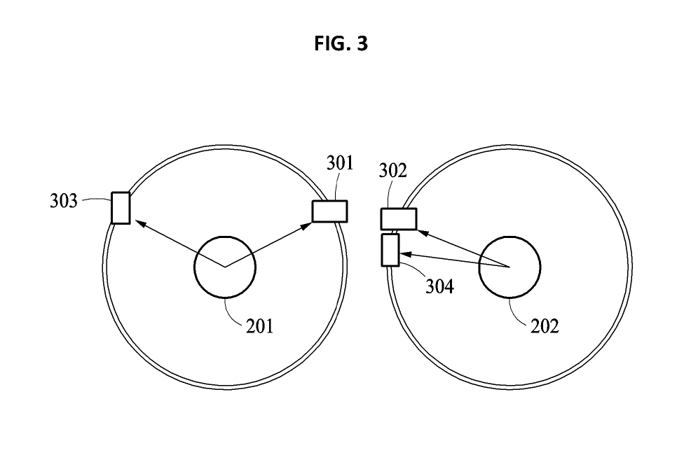

FIG. 3 is a diagram illustrating an example in which two sound signal obtaining apparatuses obtain sound signals based on arrangements of sound sources according to an example embodiment.

Two circles illustrated in FIG. 3 indicate virtual spaces of the sound signal obtaining apparatuses 201 and 202. The virtual spaces are spaces in which sound signals obtained as different results from the sound signal obtaining apparatuses 201 and 202 by a sound signal processing apparatus are represented based on the sound signal obtaining apparatuses 201 and 202.

The sound signal processing apparatus may determine a direction of each of the sound sources 203 and 204 relative to the sound signal obtaining apparatuses 201 and 202. Based on the directions of the sound sources 203 and 204 relative to positions of the sound signal obtaining apparatuses 201 and 202, the sound signals obtained by the sound signal obtaining apparatuses 201 and 202 may have a time difference or a level difference. Here, the sound signal processing apparatus may determine the direction of each of the sound sources 203 and 204 relative to the positions of the sound signal obtaining apparatuses 201 and 202 based on the time difference or the level difference between the sound signals. In an example, the sound signal processing apparatus indicates the determined direction of each of the sound sources 203 and 204 by an angle based on a preset reference.

The sound signal processing apparatus may divide an entire frequency band of the sound signals to a plurality of partial frequency bands. Subsequently, the sound signal processing apparatus may determine the direction of each of the sound sources 203 and 204 for each of the partial frequency bands of the sound signals. The sound signals of the entire frequency band may include the sound signals of the sound sources 203 and 204, and the sound signals of the partial frequency bands may include the sound signals of a portion of sound signals 203 and 204. Thus, a method by which the sound signal processing apparatus uses the sound signals of the partial frequency bands may more effectively determine the direction of each of the sound sources 203 and 204 than a method by which the sound signal processing apparatus uses the sound signals of the entire frequency band.

Referring to FIG. 3, in the virtual space of the first sound signal obtaining apparatus 201, the first sound source 203 is positioned at a virtual position 301 and the second sound source 204 is positioned at a virtual position 303. In the virtual space of the second sound signal obtaining apparatus 202, the first sound source 203 is positioned at a virtual position 302 and the second sound source 204 is positioned at a virtual position 304.

The sound signals obtained by the sound signal obtaining apparatuses 201 and 202 may be unrelated to accurate positions of the sound sources 203 and 204. However, the sound signal processing apparatus may determine directions of the sound sources 203 and 204 relative to the sound signal obtaining apparatuses 201 and 202. Thus, the sound sources 203 and 204 may be positioned at the virtual positions 301, 302, 303, and 304 based on the directions of the sound signal obtaining apparatuses 201 and 202.

The virtual spaces may be spaces in which sound signals recognized by a user are arranged when the user uses the sound signals obtained by the sound signal obtaining apparatuses 201 and 202. For example, when the user uses a sound signal obtained by the first sound signal obtaining apparatus 201, the user may hear the sound signals of the sound sources 203 and 204 positioned at the virtual positions 301 and 303 based on a position of the user.

The sound signal processing apparatus may determine coordinates of the sound sources 203 and 204 in the recording space based on the direction of each of the sound signal obtaining apparatuses 201 and 202 relative to the identical sound sources 203 and 204. For this, the sound signal processing apparatus may match the sound signals obtained by the different sound signal obtaining apparatuses 201 and 202 by each of the identical sound sources 203 and 204. For example, when the sound signal processing apparatus matches the sound signals by each of the identical sound sources 203 and 204, the sound signal processing apparatus may determine that the determined direction of each of the sound signal obtaining apparatuses 201 and 202 relative to the first sound source 203 is a direction relative to the identical first sound source 203.

The sound signal processing apparatus may match the sound signals based on features of the sound signals of the identical sound sources 203 and 204. The sound signals of the identical sound sources 203 and 204 among the sound signals obtained by the sound signal obtaining apparatuses 201 and 202 at different positions may have a relatively high correlation. Thus, the sound signal processing apparatus may match the sound signals by each of the identical sound sources 203 and 204 based on the correlation between the obtained sound signals. In an example, when the sound signal processing apparatus matches the sound signals obtained from the sound signal obtaining apparatuses 201 and 202 by sound signals having the relatively high correlation, the matched sound signals may be the sound signals of the identical sound sources 203 and 204.

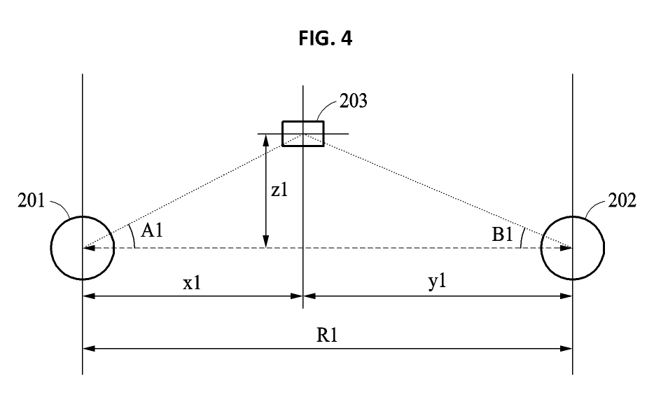

FIG. 4 is a diagram illustrating an example of determining a position of a sound source positioned between two sound signal obtaining apparatuses in a recording space according to an example embodiment.

A sound signal processing apparatus may determine coordinates of the sound sources 203 and 204 in the recording space using the sound signals matched by each of the sound sources 203 and 204. In an example, the sound signal processing apparatus may determine the coordinates of the first sound source 203 in the recording space based on a direction of the first sound source 203 relative to each of the sound signal obtaining apparatuses 210 and 202 and a distance between the sound signal obtaining apparatuses 201 and 202.

Referring to FIG. 4, A1 indicates an angle between the first sound source 203 and the sound signal obtaining apparatus 201, and B1 indicates an angle between the first sound source 203 and the sound signal obtaining apparatus 202. R1 indicates a distance between the sound signal obtaining apparatuses 201 and 202. x1 indicates a horizontal distance between the first sound source 203 and the sound signal obtaining apparatus 201, and y1 indicates a horizontal distance between the first sound source 203 and sound signal obtaining apparatus 202. z1 indicates a vertical distance between the first sound source 203 and a line connecting the sound signal obtaining apparatuses 201 and 202.

The sound signal processing apparatus may determine x1, y1, and z1 based on A1, B1, and R1. Detailed description about Equation 1 is provided below.

$$x 1 = R 1 * \frac{tan B 1}{tan A 1 + tan B 1} \\ y 1 = R 1 * \frac{tan A 1}{tan A 1 + tan B 1} \\ z 1 = R 1 * \frac{tan A 1 + tan B 1}{tan A 1 + tan B 1} \qquad [ Equation 1 ]$$

The sound signal processing apparatus may determine the coordinates of the first sound source 203 in the recording space based on determined x1, y1, and z1. In an example, the sound signal processing apparatus may determine the coordinates of the first sound source 203 corresponding to an origin in the recording space based on x1, y1, and z1. However, this is only an example. Any position in the recording space may be used as a reference by the sound signal processing apparatus to determine coordinates.

Although FIG. 4 illustrates the first sound source 203, the example is not limited thereto. In an example, the sound signal processing apparatus may determine coordinates of a predetermined sound source positioned between the sound signal obtaining apparatuses 201 and 202 in the recording space using Equation 1.

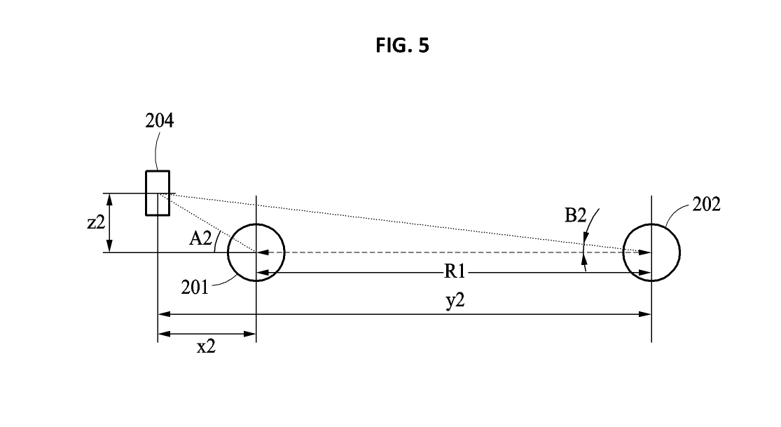

FIG. 5 is a diagram illustrating an example of determining a position of a sound source not positioned between two sound signal obtaining apparatuses in a recording space according to an example embodiment.

A sound signal processing apparatus may determine the coordinates of the sound sources 203 and 204 in the recording space using sound signals matched by each of the identical sound sources 203 and 204. In an example, the sound signal processing apparatus may determine coordinates of the second sound source 204 in the recording space based on a direction of the second sound source 204 relative to each of the sound signal obtaining apparatuses 201 and 202, and a distance between the sound signal obtaining apparatuses 201 and 202.

Referring to FIG. 5, A2 indicates an angle between the second sound source 204 and the sound signal obtaining apparatus 201, and B2 indicates an angle between the second sound source 204 and the sound signal obtaining apparatus 202. R1 indicates a distance between the sound signal obtaining apparatuses 201 and 202. x2 indicates a horizontal distance between the second sound source 204 and the sound signal obtaining apparatus 201, and y2 indicates a horizontal distance between the second sound source 204 and the sound signal obtaining apparatus 202. z2 indicates a vertical distance between the second sound source 204 and a line connecting the sound signal obtaining apparatuses 201 and 202.

The sound signal processing apparatus may determine x2, y2, and z2 based on A2, B2, and R1. Detailed description about Equation 2 is provided below.

$$x 2 = R 1 * \frac{tan B 2}{tan A 2 - tan B 2} \\ y 2 = R 1 * \frac{tan A 2}{tan A 2 - tan B 2} \\ z 2 = R 1 * \frac{tan A 2 * tan B 2}{tan A 2 - tan B 2} \qquad [ FIG . 2 ]$$

The sound signal processing apparatus may determine the coordinates of the second sound source 204 in the recording space based on determined x2, y2, and z2. In an example, the sound signal processing apparatus may determine the coordinates of the second sound source 204 corresponding to an origin in the recording space based on x2, y2, and z2. However, this is only an example. Any position in the recording space may be used as a reference by the sound signal processing apparatus to determine coordinates.

Although FIG. 5 illustrates the second sound source 204, the example is not limited thereto. In an example, the sound signal processing apparatus may determine coordinates of a predetermined sound source not positioned between the sound signal obtaining apparatuses 201 and 202 in the recording space using Equation 2.

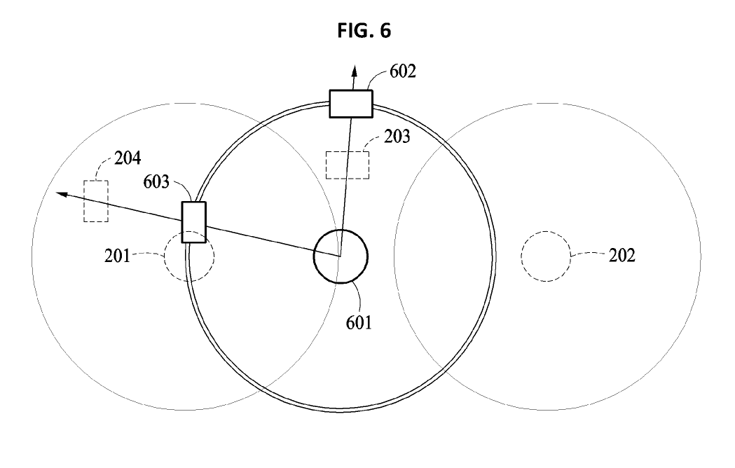

FIG. 6 is a diagram illustrating an example of generating a sound signal corresponding to a virtual position of a sound signal obtaining apparatus in a recording space according to an example embodiment.

Circles illustrated in FIG. 6 indicate virtual spaces represented based on a virtual position 601 of a sound signal obtaining apparatus. The virtual spaces are spaces in which sound signals generated by a sound signal processing apparatus are represented based on the virtual position 601 of the sound signal obtaining apparatus.

Referring to FIG. 6, the first sound source 203 is positioned at a virtual position 602, and the second sound source 204 is positioned at a virtual position 603. The virtual position 601 of the sound signal obtaining apparatus illustrated in FIG. 6 is only an example. The virtual position 601 of the sound signal obtaining apparatus may include any predetermined position in a recording space.

The sound signal processing apparatus may generate a sound signal corresponding to the virtual position 601 of the sound signal obtaining apparatus 201 or 202 in the recording space based on coordinates of the sound sources 203 and 204 and matched sound signals in the recording space.

In an example, the sound signal processing apparatus may determine relative distances and directions of the sound sources 203 and 204 relative to the virtual position 601 of the sound signal obtaining apparatus 201 or 202 based on the determined coordinates of the sound sources 203 and 204. Then, the sound signal processing apparatus may generate sound signals corresponding to the relative distances and directions of the sound sources 203 and 204 relative to the determined virtual position 601 based on the matched sound signals. The sound signal processing apparatus may provide a virtual reality by generating the sound signals of the sound sources 203 and 204 positioned at the virtual positions 602 and 603.

A user using the provided virtual reality may hear sound signals corresponding to positions of the sound signal obtaining apparatuses 201 and 202, and may also hear the sound signal corresponding to the virtual position 601 of the sound signal obtaining apparatus 201 or 202. Thus, the user may hear sound signals corresponding to all positions in the recording space. For example, when the user uses a device, for example, a head mounted display (HMD), for verifying a change of a user position, the user may hear a sound signal corresponding to a changing position of user.

The virtual position 601 of the sound signal obtaining apparatus 201 or 202 may be on a line connecting the sound signal obtaining apparatuses 201 and 202. Here, because the line connecting the sound signal obtaining apparatuses 201 and 202 is an intermediate pathway between the sound signal obtaining apparatuses 201 and 202, the sound signals may be more effectively generated than when virtual positions of the sound signal obtaining apparatuses 201 and 202 are present at different positions. Here, the user may hear sound signals corresponding to a rotation direction of a user's head. In addition, the user may move on the line connecting the sound signal obtaining apparatuses 201 and 202. The user may hear sound signals corresponding to a position of the moving user.

When the sound signals are obtained from the sound signal obtaining apparatuses 201 and 202 provided in various arrangements, the sound signal processing apparatus may provide a virtual reality including various effects. In an example, sound signals are obtained from a single sound signal obtaining apparatus for obtaining sound signals in a 360-degree direction, and from sound obtaining apparatuses for obtaining sound signals only in a predetermined direction in the recording space. Thus, the sound signal processing apparatus may generate sound signals extended with respect to a predetermined direction using the obtained sound signals.

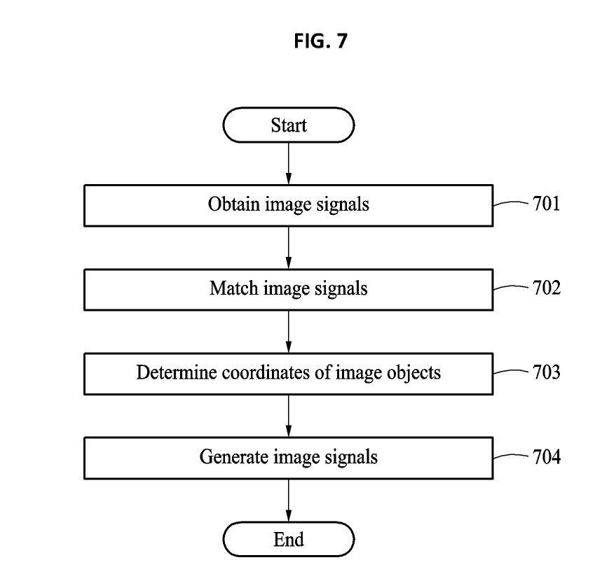

FIG. 7 is a flowchart illustrating a method of providing a virtual reality using image signal obtaining apparatuses according to an example embodiment.

A plurality of image signal obtaining apparatuses may obtain image signals in a recording space including a plurality of image objects and a plurality of backgrounds. Here, the recording space includes all spaces in which image signals are obtainable. The recording space is not limited to a predetermined place or an indoor space. The image signal obtaining apparatuses may be present at different recording positions in the recording space. An image signal processing apparatus may obtain the image signals from the image signal obtaining apparatuses. Subsequently, the image signal processing apparatus may perform the method of providing virtual reality using the obtained image signals.

In operation 701, the image signal processing apparatus obtains the image signals from the image signal obtaining apparatuses in the recording space. The plurality of image signal obtaining apparatuses may be provided, and the image signal obtaining apparatuses may be present at different positions. Also, the image signal obtaining apparatuses may be combined with other apparatuses, or included in other apparatuses. The image signals obtained by the image signal obtaining apparatuses include an omnidirectional sound signal including a 360-degree sound signal.

In operation 702, the image signal processing apparatus matches the image signals by each identical image object by comparing the obtained image signals. The image signal processing apparatus may match, by each identical image object, the image signals obtained based on features of image signals with respect to the identical image object. In an example, the image signal processing apparatus may match the image signals by each identical image object based on an image matching method. A color, a brightness, and a size may vary depending on a position of an image signal obtaining apparatus. Thus, the image signal processing apparatus may match the image signals by each identical image object by normalizing or refining the image signals obtained from the image signal obtaining apparatus.

In operation 703, the image signal processing apparatus determines coordinates of image objects in the recording space using the matched image signals. In an example, the image signal processing apparatus may determine the coordinates of the image objects in the recording space based on directions of the image objects relative to the image signal obtaining apparatuses and distances between the image signal obtaining apparatuses. The, the image signal processing apparatus may determine relative positions of the image objects relative to a predetermined position in the recording space based on the coordinates of the image objects in the recording space.

In operation 704, the image signal processing apparatus generates image signals corresponding to a predetermined position in the recording space based on the matched image signals and the coordinates of the image objects in the recording space. The predetermined position may be a virtual position of the image signal obtaining apparatus. In an example, the image signal processing apparatus may determine relative positions of the image objects relative to the virtual position of the image signal obtaining apparatus. In addition, the image signal processing apparatus may generate new image signals corresponding to the determined relative positions by controlling the image signals based on the relative positions of the image objects. In another example, the image signal processing apparatus may generate the image signals corresponding to the predetermined position in the recording space based on an image processing technology. The image processing technology may include extracting of an object image, generating of an intermediate viewpoint image, stitching of partial background images, and replacing of an image occluded by other image signal obtaining apparatuses. However, this is only an example. Any method of technology for generating image signals is included in the present disclosure. The image signals generated by the image signal processing apparatus may include an omnidirectional image signal including a 360-degree image signal.

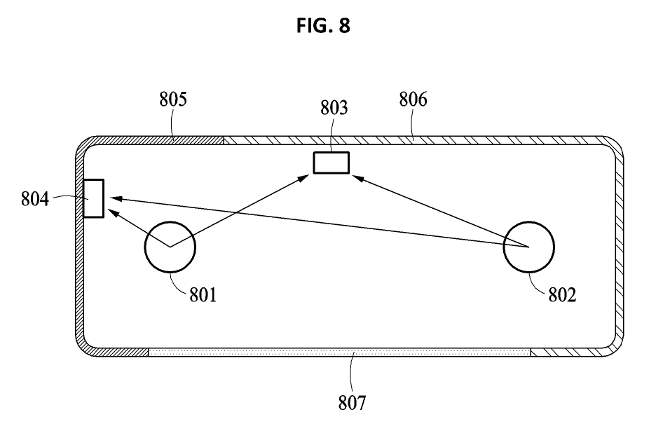

FIG. 8 is a diagram illustrating a process of obtaining image signals of backgrounds and image objects in a recording space using two image signal obtaining apparatuses according to an example embodiment.

FIG. 8 illustrates a recording space including a first image signal obtaining apparatus 801, a second image signal obtaining apparatus 802, a first image object 803, a second image object 804, and backgrounds 805, 806, and 807.

The plurality of image signal obtaining apparatuses 801 and 802 for obtaining image signals may be disposed in the recording space. Although FIG. 8 illustrates two image signal obtaining apparatuses 801 and 802 and two image objects 803 and 804, the present disclosure is not limited thereto. In an example, the image signal obtaining apparatuses 801 and 802 may include a camera for omnidirectionally obtaining image signals by rotating 360 degrees.

In another example, the image signal obtaining apparatuses 801 and 802 include a plurality of cameras for separately obtaining 360-degree image signals. However, this is only an example. Any type of apparatuses for obtaining image signals at 360 degrees may be in the present disclosure.

In still another example, image objects may include feature points used by an image signal processing apparatus to determine that the image objects are associated with an identical image. The image signal processing apparatus may extract a feature point of an image obtained through an image feature point extracting technology. In a further example, a number of the image objects 803 and 804 present in the recording space may correspond to a predetermined number. For example, the image signals obtained by the image signal obtaining apparatuses 801 and 802 may include an omnidirectional image signal.

The image signal obtaining apparatuses 801 and 802 may obtain the image signals from the image objects 803 and 804 present in the recording space. Then, the image signal processing apparatus may estimate positions of the image objects 803 and 804 in the recording space using the image signals obtained by the image signal obtaining apparatuses 801 and 802. The positions of the image signal obtaining apparatuses 801 and 802 may be differently set. Because positions and directions of the image objects 803 and 804 and the image signal obtaining apparatuses 801 and 802 are different, the image signal obtaining apparatuses 801 and 802 positioned in the recording space may obtain different results of image signals even though the image signals are associated with an identical image object. In an example, the image signals obtained by the image signal obtaining apparatuses 801 and 802 may have different colors, brightnesses, and proportions even though the image signals are associated with an identical image object and an identical background.

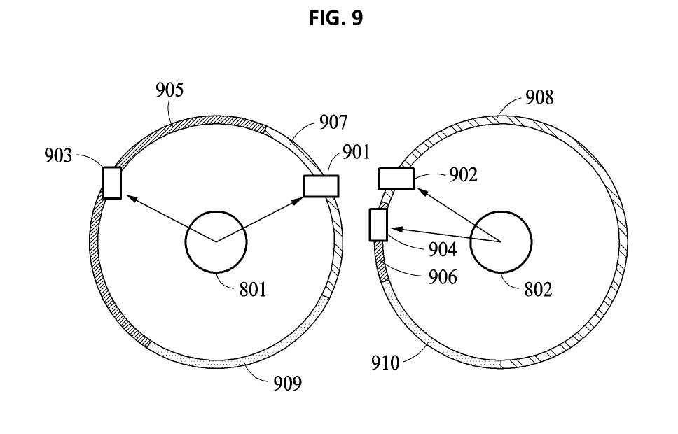

FIG. 9 is a diagram illustrating an example in which two image signal obtaining apparatuses obtain image signals based on arrangements of image objects and backgrounds according to an example embodiment.

Two circles illustrated in FIG. 9 are virtual spaces of the image signal obtaining apparatuses 801 and 802. The virtual spaces are spaces in which image signals obtained as different results from the sound signal obtaining apparatuses 801 and 802 by the image signal processing apparatus are represented based on the image signal obtaining apparatuses 801 and 802.

The virtual spaces may be spaces in which the image signals recognized by a user are arranged when the user uses the image signals obtained by the image signal obtaining apparatuses 801 and 802. For example, when the user uses an image signal obtained by the first image signal obtaining apparatus 801, the user may recognize image signals of the image objects 803 and 804 positioned at virtual positions 901 and 903 and the backgrounds 805, 806, and 807 positioned at virtual positions 905, 907, and 909 based on a position of the user.

Referring to FIG. 9, in the virtual space of the first image signal obtaining apparatus 801, the first image object 803 is positioned at the virtual position 901 and the second image object 804 is positioned at the virtual position 903. In the virtual space of the first image signal obtaining apparatus 801, the backgrounds 805, 806, and 807 are positioned at the virtual positions 905, 907, and 909. In the virtual space of the second image obtaining apparatus 802, the first image object 803 is positioned at the virtual position 902 and the second image object 804 is positioned at the virtual position 904. In the virtual space of the second image obtaining apparatus 802, the backgrounds 805, 806, and 807 are positioned at the virtual positions 906, 908, and 910. The backgrounds 805, 806, and 807 are positioned at the virtual positions 905, 906, 907, 908, 909, and 910 in proportion different from that of a recording space. In addition, positions at which the backgrounds 805, 806, and 807 are occluded by the image objects 803 and 804 may vary depending on a virtual space.

The image signal processing apparatus may determine coordinates of the image objects 803 and 804 in the recording space based on a direction of each of the image signal obtaining apparatuses 801 and 802 relative to the identical image objects 803 and 804. For this, the image signal processing apparatus may match the image signals obtained by the different image signal obtaining apparatuses 801 and 802 by each of the identical image objects 803 and 804. For example, when the image signal processing apparatus matches the image signals by each of the identical image objects 803 and 804, the image signal processing apparatus may verify that the direction of each of the image signal obtaining apparatuses 801 and 802 relative to the determined first image object 803 is relative to the identical first image object 803.

The image signal processing apparatus may match the image signals based on features of the image signals of the identical image objects 803 and 804. In an example, the image signal processing apparatus may match the image signals by each of identical image objects based on an image matching method. For example, the image signal processing apparatus may extract feature points from image signals obtained from the image signal obtaining apparatuses 801 and 802. The image signal processing apparatus may match the image signals based on a similarity between the extracted feature points. In another example, the image signal processing apparatus may match the image signals by each of the identical image objects by normalizing and refining the image signals. Here, the image signals with respect to the identical image objects may have different colors, brightnesses, and proportions. Thus, when the image signal processing apparatus normalizes and refines the obtained image signals, the image signal processing apparatus may effectively match the image signals. For example, the image signal processing apparatus may normalize and refine the obtained images based on a stitching technology.

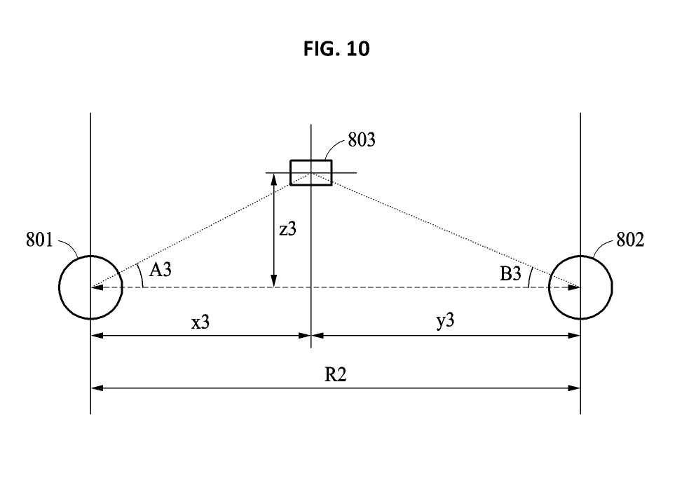

FIG. 10 is a diagram illustrating an example of determining a position of an image object positioned between two image signal obtaining apparatuses in a recording space according to an example embodiment.

The image signal processing apparatus may determine coordinates of the image objects 803 and 804 in a recording space using the image signals matched by each of the identical image objects 803 and 804. In an example, the image signal processing apparatus may determine the coordinates of the first image object 803 in the recording space based on a direction of the first image object 803 relative to each of the image signal obtaining apparatuses 801 and 802 and a distance between the image signal obtaining apparatuses 801 and 802.

Referring to FIG. 10, A3 indicates an angle between the first image object 803 and the image signal obtaining apparatus 801, and B3 indicates an angle between the first image object 803 relative to the image signal obtaining apparatus 802. R2 indicates a distance between the image signal obtaining apparatuses 801 and 802. x3 indicates a horizontal distance between the first image object 803 and the image signal obtaining apparatus 801, and y3 indicates a horizontal distance between the first image object 803 and the image signal obtaining apparatus 802. z3 indicates a vertical distance between the first image object 803 and a line connecting the image signal obtaining apparatuses 801 and 802.

The image signal processing apparatus may obtain x3, y3, and z3 based on A3, B3, and R2. Detailed description about Equation 3 is provided below.

$$x 3 = R 2 * \frac{tan B 3}{tan A 3 + tan B 3} \\ y 3 = R 2 * \frac{tan A 3}{tan A 3 + tan B 3} \\ z 3 = R 2 * \frac{tan A 3 * tan B 3}{tan A 3 + tan B 3} \qquad [ Equation 3 ]$$

The image signal processing apparatus may determine the coordinates of the first image object 803 in the recording space based on determined x3, y3, and z3. In an example, the image signal processing apparatus may determine the coordinates of the first image object 803 using a center of the recording space as an origin based on x3, y3, and z3. However, this is only an example. Any position in the recording space may be used as a reference by the image signal processing apparatus to determine coordinates.

Although FIG. 10 illustrates the first image object 803, the example is not limited thereto. In an example, the image signal processing apparatus may determine coordinates of a predetermined image object positioned between the image signal obtaining apparatuses 801 and 802 in the recording space using Equation 3.

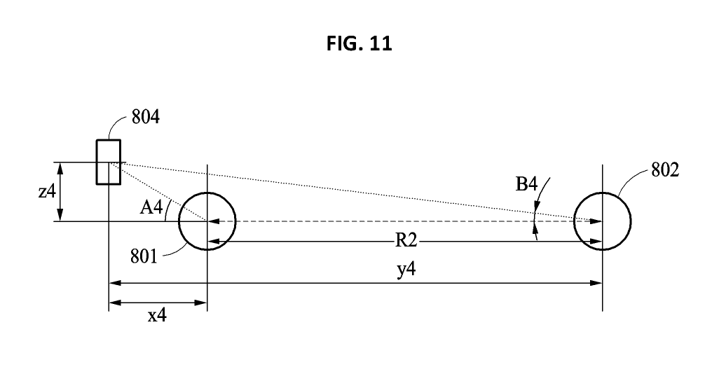

FIG. 11 is a diagram illustrating an example of determining a position of an image object not positioned between two image signal obtaining apparatuses in a recording space according to an example embodiment.

Referring to FIG. 11, A4 indicates an angle between the second image object 804 and the image signal obtaining apparatus 801, and B4 indicates an angle between the second image object 804 and the image signal obtaining apparatus 802. R2 indicates a distance between the predetermined image signal obtaining apparatuses 801 and 802. x4 indicates a horizontal distance between the second image object 804 and the image signal obtaining apparatus 801, and y4 indicates a horizontal distance between the second image object 804 and the image signal obtaining apparatus 802. z4 indicates a vertical distance between the second image object 804 and a line connecting the image signal obtaining apparatuses 801 and 802.

The image signal processing apparatus may obtain x4, y4, and z4 based on A4, B4, and R2. Detailed description about Equation 4 is provided below.

$$x 4 = R 2 * \frac{tan B 4}{tan A 4 + tan B 4} \\ y 4 = R 2 * \frac{tan A 4}{tan A 4 + tan B 4} \\ z 4 = R 2 * \frac{tan A 4 * tan B 4}{tan A 4 + tan B 4} \qquad [ Equation 4 ]$$

The image signal processing apparatus may determine coordinates of the second image object 804 in the recording space based on determined x4, y4, and z4. In an example, the image signal processing apparatus may determine the coordinates of the second image object 804 using a center of the recording space as an origin based on x4, y4, and z4. However, this is only on example. Any position in the recording space may be used as a reference by the image signal processing apparatus to determine the coordinates of the image objects 803 and 804.

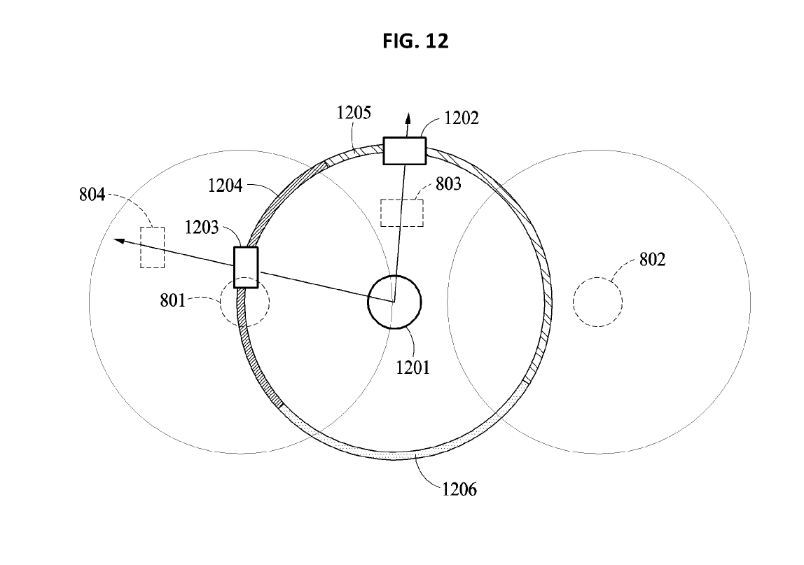

FIG. 12 is a diagram illustrating an example of generating an image signal corresponding to a virtual position of an image signal obtaining apparatus in a recording space according to an example embodiment.

Circles illustrated in FIG. 12 indicate virtual spaces represented based on a virtual position 1201 of an image signal obtaining apparatus. The virtual spaces are spaces in which image signals generated by the image signal processing apparatus are represented based on the virtual position 1201 of the image signal obtaining apparatus.

Referring to FIG. 12, the first image object 803 is positioned at a virtual position 1202 and the second image object 804 is positioned at a virtual position 1203. The backgrounds 805, 806, and 807 are positioned at virtual positions 1204, 1205, and 1206. The position 1201 of the image signal obtaining apparatus illustrated in FIG. 12 is only an example. The virtual position 1201 of the image signal obtaining apparatus may include any predetermined position in the recording space.

The image signal processing apparatus may generate image signals corresponding to the virtual position 1201 of the image signal obtaining apparatuses 801 and 802 in the recording space based on coordinates of the image objects 803 and 804 in the recording space and the image signals matched by each of the identical image objects 803 and 804.

In an example, the image signal processing apparatus may determine relative distances and directions of the image objects 803 and 804 relative to the virtual position 1201 of the image signal obtaining apparatuses 801 or 802 based on the determined coordinates of the image objects 803 and 804. Then, the image signal processing apparatus may generate the image signals corresponding to the virtual position 1201 using the matched image signals. The image signal processing apparatus may provide a virtual reality by generating the image signals corresponding to the virtual positions 1202, 1203, 1204, 1205, and 1206 of the image objects 803 and 804 and the backgrounds 805, 806, and 807.

The image signal processing apparatus may generate the image signals corresponding to the virtual position 1201 of the image signal obtaining apparatuses 801 or 802 based on an image processing technology. The image processing technology may include extracting of an object image, generating of an intermediate viewpoint image, stitching of partial background images, and replacing of an image occluded by other image signal obtaining apparatuses 801 and 802. However, this is only an example. Any type of image processing technology for generating the image signals is in the present disclosure.

In an example, the image processing apparatus may verify whether feature points are associated with an identical image from obtained images. Then, the image signal processing apparatus may extract image signals of the feature points from the obtained images.

In another example, the image signal processing apparatus may generate an image signal of an intermediate viewpoint between two viewpoints at which an image is photographed using the image signals obtained from the image signal obtaining apparatuses 801 and 802. For example, the image signal processing apparatus may generate the image signal of the intermediate viewpoint by synthesizing, in different proportions, the image signals obtained based on distances between the image signal obtaining apparatuses 801 and 802 relative to a position of the intermediate viewpoint.

In still another example, the image signal processing apparatus may reduce distortion of the backgrounds 805, 806, and 807 and connect the backgrounds 805, 806, and 807 of the images obtained from the image signal obtaining apparatuses 801 and 802. In a further example, the image signal processing apparatus may replace an image signal of the image signal obtaining apparatus 801 partially occluded by the image signal obtaining apparatus 802 with an image signal of the image signal obtaining apparatus 802. Conversely, the image signal processing apparatus may replace an image signal of the image signal obtaining apparatus 802 partially occluded by the image signal obtaining apparatus 801 with an image signal of the image signal obtaining apparatus 801. For example, the background 804 of the image obtained from the second image signal obtaining apparatus 802 may be partially occluded by the first image signal obtaining apparatus 801. Here, the image signal processing apparatus may delete the first image signal obtaining apparatus 801 from an image by replacing an image signal of the occluded background 804 with an image signal of the background 804 obtained by the first image signal obtaining apparatus 801.

A user using the provided virtual reality may view the image signals corresponding to the positions of the image signal obtaining apparatuses 801 and 802, and may also view an image corresponding to the virtual position 1201 of the image signal obtaining apparatuses 801 or 802. Thus, the user may view image signals corresponding to all positions in a recording space. For example, when the user views an image signal generated by the image signal processing apparatus using an apparatus for verifying a change of a user position, the user may view an image signal corresponding to a changing position.

The virtual position 1201 of the image signal obtaining apparatuses 801 or 802 may be on a line connecting the image signal obtaining apparatuses 801 and 802. Here, because the line connecting the image signal obtaining apparatuses 801 and 802 is an intermediate pathway between the image signal obtaining apparatuses 801 and 802, the image signal obtaining apparatuses 801 and 802 may more effectively generate image signals than when virtual positions of the image signal obtaining apparatuses 801 and 802 are present at different positions.

According to example embodiments described herein, a method of providing a virtual reality in which a user moves based on coordinates of sound sources and sound signals obtained from sound signal obtaining apparatuses present at different recording positions is provided.

According to example embodiments described herein, a method of providing a virtual reality in which a user moves based on coordinates of image objects and image signals obtained from image signal obtaining apparatuses present at different recording positions is provided.

According to example embodiments described herein, an apparatus for providing a virtual reality in which a user moves based on coordinates of sound sources and omnidirectional sound signals obtained from sound signal obtaining apparatuses present at different recording positions is provided.

According to example embodiments described herein, an apparatus for providing a virtual reality in which a user moves based on coordinates of image objects and image signals obtained from image signal obtaining apparatuses present at different recording positions.

The components described in the exemplary embodiments of the present invention may be achieved by hardware components including at least one DSP (Digital Signal Processor), a processor, a controller, an ASIC (Application Specific Integrated Circuit), a programmable logic element such as an FPGA (Field Programmable Gate Array), other electronic devices, and combinations thereof. At least some of the functions or the processes described in the exemplary embodiments of the present invention may be achieved by software, and the software may be recorded on a recording medium. The components, the functions, and the processes described in the exemplary embodiments of the present invention may be achieved by a combination of hardware and software.

The methods according to the above-described example embodiments may be recorded in non-transitory computer-readable media including program instructions to implement various operations of the above-described example embodiments. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher level code that may be executed by the computer using an interpreter. The above-described devices may be configured to act as one or more software modules in order to perform the operations of the above-described example embodiments, or vice versa.

A number of example embodiments have been described above. Nevertheless, it should be understood that various modifications may be made to these example embodiments. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A method of providing a virtual reality performed by a processor of a sound signal processing apparatus, the method comprising:
obtaining sound signals of a plurality of sound sources from a plurality of sound signal obtaining apparatuses present at different recording positions in a recording space;
determining a direction of each of the sound sources relative to positions of the sound signal obtaining apparatuses based on the sound signals;
matching the sound signals by each identical sound source;
determining coordinates of the sound sources in the recording space based on the matched sound signals; and
generating the sound signals corresponding to virtual positions of the sound signal obtaining apparatuses in the recording space based on the determined coordinates of the sound sources in the recording space and the matched sound signals.

2. The method of claim 1, wherein the determining of the direction of each of the sound sources comprises determining the direction of each of the sound sources based on at least one of a time difference or a level difference between the sound signals of the sound sources from the sound signal obtaining apparatuses present at the different recording positions.

3. The method of claim 1, wherein the determining of the direction of each of the sound sources comprises determining the direction of each of the sound sources for each of a plurality of partial frequency bands divided from an entire frequency band of the sound signals.

4. The method of claim 1, wherein the matching of the sound signals by each identical sound source comprises matching the sound signals by each identical sound source based on a correlation between the sound signals.

5. The method of claim 1, wherein the determining of the coordinates of the sound sources in the recording space comprises:
determining vertical distances between the sound signal obtaining apparatuses and the sound sources and horizontal distances between the sound signal obtaining apparatuses and the sound sources based on angles between the sound signal obtaining apparatuses and the sound sources and distances between the sound signal obtaining apparatuses; and
determining the coordinates of the sound sources based on the vertical distances and the horizontal distances.

6. The method of claim 1, wherein the virtual positions of the sound signal obtaining apparatuses are on a line connecting two sound signal obtaining apparatuses corresponding to the recording positions.

7. A method of providing a virtual reality performed by a processor of an image signal processing apparatus, the method comprising:
obtaining image signals of a plurality of image objects from a plurality of image signal obtaining apparatuses present at different recording positions in a recording space;
matching the image signals by each identical image object;
determining coordinates of the image objects in the recording space based on the matched image signals; and
generating the image signals corresponding to virtual positions of the image signal obtaining apparatuses in the recording space based on the determined coordinates of the image objects in the recording space and the matched image signals.

8. The method of claim 7, wherein the matching of the image signals by each identical image object comprises:
matching the image signals by each identical image object based on an image matching method; and
normalizing and refining the image signals.

9. The method of claim 7, wherein the determining of the coordinates of the image objects in the recording space comprises:
determining vertical distances between the image signal obtaining apparatuses and the image objects and horizontal distances between the image signal obtaining apparatuses and the image objects based on angles between the image signal obtaining apparatuses and the image objects and distances between the image signal obtaining apparatuses; and
determining the coordinates of the image objects based on the vertical distances and the horizontal distances.

10. The method of claim 7, wherein the generating of the image signals corresponding to the virtual positions of the image signal obtaining apparatuses comprises at least one of extracting an object image, generating an intermediate viewpoint image, stitching partial background images, and replacing an image occluded by other image signal obtaining apparatuses.

11. The method of claim 7, wherein the virtual positions of the image signal obtaining apparatuses are on a line connecting two image signal obtaining apparatuses corresponding to the recording positions.

12. An image signal processing apparatus for performing a method of providing a virtual reality, the apparatus comprising:
a processor configured to obtain image signals of a plurality of image objects from a plurality of image signal obtaining apparatuses present at different recording positions in a recording space, match the image signals by each identical image object, determine coordinates of the image objects in the recording space based on the matched image signals, and generate the image signals corresponding to virtual positions of the image signal obtaining apparatuses in the recording space based on the determined coordinates of the sound sources in the recording space and the matched sound signals.
